(19) United States
(12) Patent Application Publication
(10) Pub. No.: US 2017/0307428 A1
(43) Pub. Date: Oct. 26, 2017

(54) Thermal, Flow Measuring Device

(71) Applicant: Endress + Hauser Flowtec AG, Reinach (CH)

(72) Inventors: Krishna Malladi, Hyderabad-Telagana (IN); Martin Arnold, Reinach (CH); Michel Wagner, Birsfelden (CH)

(21) Appl. No.: 15/520,102

(22) PCT Filed: Sep. 2, 2015
(86) PCT No.: PCT/EP2015/070022

§ 371 Date: Apr. 19, 2017

(30) Foreign Application Priority Data
Oct. 21, 2014 (DE) 102014115305.7

(51) Int. Cl. G01F 1/684; G01F 1/69; G01P 13/00; G01F 1/696

(52) U.S. Cl. CPC G01F 1/6847; G01P 13/0046; G01F 1/69; G01F 1/6965

(57) ABSTRACT

A thermal, flow measuring device for ascertaining a mass flow or a flow velocity of a medium in a pipe. The thermal, flow measuring device has at least one measuring transducer with at least a first and a second sensor element. The first sensor element has a pin-shaped metal sleeve, which has a lowest point on a wall of the metal sleeve in the gravitational direction, wherein there is arranged in the metal sleeve at least one heating means, especially a heatable temperature sensor. The heating means is arranged in the metal sleeve and above the aforementioned point in the gravitational direction, in such a manner that the maximum heat input per unit area from the heating means into the medium occurs in the gravitational direction above the point.

The present invention relates to a thermal, flow measuring device as defined in the preamble of claim 1.

Known are thermal, flow measuring devices, which are embodied in the form of a rod. The rod is inserted into an existing pipeline or installed in a measuring tube. Terminally arranged on the rod are two, metal, pin-shaped sleeves, so-called prongs. Arranged in one of the two sleeves is a heater and in the other of the two sleeves a temperature sensor for ascertaining the temperature of the medium. The principle, by which a thermal flow meter works, has been known for many years.

The use of a thermal flow meter can, however, depending on type and composition of the measured medium, present problems. Thus, in the case of measuring gases and vapors, liquid droplets can deposit on the surface of a shell, more exactly stated, on the tip of a shell. Usually, that is also where the main heat input into the medium from the heater occurs. While a fine and most often uniformly distributed fluid film has no effect on the measuring, heat transfer is hindered by the formation of droplets and a disturbance of the measurement signal is experienced.

It is, consequently, an object of the present invention to provide a thermal, flow measuring device and a method for ascertaining mass flow, which can also be applied in the case of droplet formation.

This object is achieved by a thermal, flow measuring device as defined in claim 1 and by a method for ascertaining mass flow as defined in claim 10.

A thermal, flow measuring device of the invention for ascertaining a mass flow or a flow velocity of a medium in a pipe includes at least one measuring transducer with at least a first and a second sensor element; wherein the first sensor element has a pin-shaped metal sleeve, which has a lowest point on a wall of the metal sleeve in the gravitational direction g, wherein there is arranged in the metal sleeve at least one heating means, preferably a heatable temperature sensor, especially a heatable resistance thermometer.

The heating means is, in such case, arranged in the metal sleeve and above the aforementioned point in the gravitational direction, in such a manner that the maximum heat input per unit area from the heating means into the medium occurs in the gravitational direction above said point.

Due to this arrangement of the heating means, a draining away of formed droplets is achieved and therewith a measuring achieved, which is essentially free of disturbance from liquid droplets.

Advantageous embodiments of a flow device of the invention are subject matter of the dependent claims.

The heating element can preferably be spaced by more than twice the diameter of the metal sleeve, especially preferably by 4 to 10 times the diameter of the metal sleeve, from said lowest point.

The metal sleeve can have e.g. a bend, wherein said lowest point is arranged in the bend.

Alternatively, the metal sleeve can be straight and the lowest point can be arranged terminally on the metal sleeve.

The second sensor element can additionally have a metal shell, in which a temperature sensor is arranged, wherein the temperature sensor is arranged essentially at the same height of the measuring transducer as the heating means of the first sensor element. In this way, the flow profile can be registered at the same height, or penetration depth, in the pipe.

In an especially advantageous embodiment of the invention, the measuring transducer can have a third sensor element, wherein the third sensor element has a pin-shaped metal sleeve, which has a lowest point on a wall of the metal sleeve in the gravitational direction g, wherein there is arranged in the metal sleeve at least one heating means, preferably a heatable temperature sensor, wherein the heating means is arranged in the metal sleeve and in the gravitational direction in the region of the aforementioned point, in such a manner that the maximum heat input per unit area from the heating means into the medium occurs in the gravitational direction at said point.

Basically, in the case of arising tendency of the measured medium for droplet formation, these droplets are formed along a prong, i.e. the metal shell, and collect on the tip. Since also the heating element, i.e. the heating means, of the sensor element is arranged in this region, a measurement error occurs, which is characteristic for droplet formation. As a result, one can, by means of the third sensor element, display (e.g. as a visual or acoustic alarm) the occurrence of droplet formation. Additionally, taking into consideration the measurement signals of the first and third sensor elements, one can quantify, how regularly droplets are formed and in which size.

The thermal, flow measuring device can advantageously have a control- and/or evaluation unit, which is adapted
a) for receiving measurement signals of the heating means of the first and third sensor elements and/or values derived therefrom; and
b) for monitoring whether droplet formation is occurring on the first sensor element.

Of course, the control- and/or evaluation unit can perform basic computing operations and also more complex mathematical calculations. Observation of the signal curve of the third sensor element can show in the case of droplet formation an excursion, i.e. a peak, which forms in the case of droplet formation and in the case of the dropping off of the droplet. This is an indication of droplet formation. Monitoring includes, in such case, mainly an output, that droplet formation is occurring. Monitoring can be done by an actual/desired value comparison. When, thus, the measurement signal has an unexpected excursion, which lies outside of an established, desired value limit and the excursion sinks within a predetermined time interval back below the desired value limit, then the user can can conclude that droplet formation is occurring. With aid of the measurement signal of the first sensor element, even a quantifying of the droplet formation can occur.

In contrast, advantageously also a quantifying of the disturbance is possible, by comparing the two measurement curves and by determining the deviation of the signal of the third sensor element from the signal of the first sensor element.

Likewise a drift monitoring can occur, e.g. drift brought about by electrical disturbances or an accretion formation. In such case, this mainly concerns a continuous and growing disturbance, while droplets only disturb the measurement signal until they drop off. Also drift is quantifiable.

A method of the invention serves for ascertaining a mass flow or a flow velocity of a gaseous- and/or vaporous medium in a pipe. This occurs by means of a thermal, flow measuring device. The thermal, flow measuring device includes at least one measuring transducer with at least a first sensor element. The sensor element is embodied in such a manner that the first sensor element has a heating means, preferably a heatable temperature sensor. This heating element is arranged in a pin-shaped shell. The pin-shaped shell is embodied in such a manner that a liquid, which in measurement operation has deposited on the shell surface, can drain into a region. Understood is that in said measurement operation a droplet formation is occurring on the surface of the measuring transducer. The heating element is in thermal contact with the measured medium. It is arranged in such a manner in the shell that the maximum heat input per unit area into the measured medium from the heating element occurs above the region of droplet formation.

Further within the scope of the invention is the use of the thermal, flow measuring device as claimed in one of claims 1-8 for detecting droplet formation during the flow measurement, as well as the use of the thermal, flow measuring device as claimed in one of claims 1-8 for quantifying the droplet formation with reference to droplet size and/or rate of droplet formation.

Other advantageous embodiments will now be described in greater detail.

It is advantageous, when the thermal, flow measuring device includes a platform, especially a rod-shaped platform, from which the two sensor elements protrude. This platform includes preferably a drainage geometry, which drains droplets, which form on the platform, laterally and away from the sensor elements. In this way, a draining of these droplets along the sensor elements is prevented.

Especially preferably, the drainage geometry can be represented as an area, which is at an angle other than 90° to the longitudinal axis of the platform and to which in the installed state the medium is exposed

To the extent that the metal sleeve is hook-shaped, it has relative to a perpendicular to the tube axis an angle of greater than 90°, especially greater than 120°.

The heating means of the first heating element has preferably both from the heating means of the third sensor element as well as also from the temperature sensor of the second sensor element preferably the same separation.

The subject matter of the invention will now be explained in greater detail based on examples of embodiments illustrated in the appended figures of the drawing. The figures of the drawing show as follows:

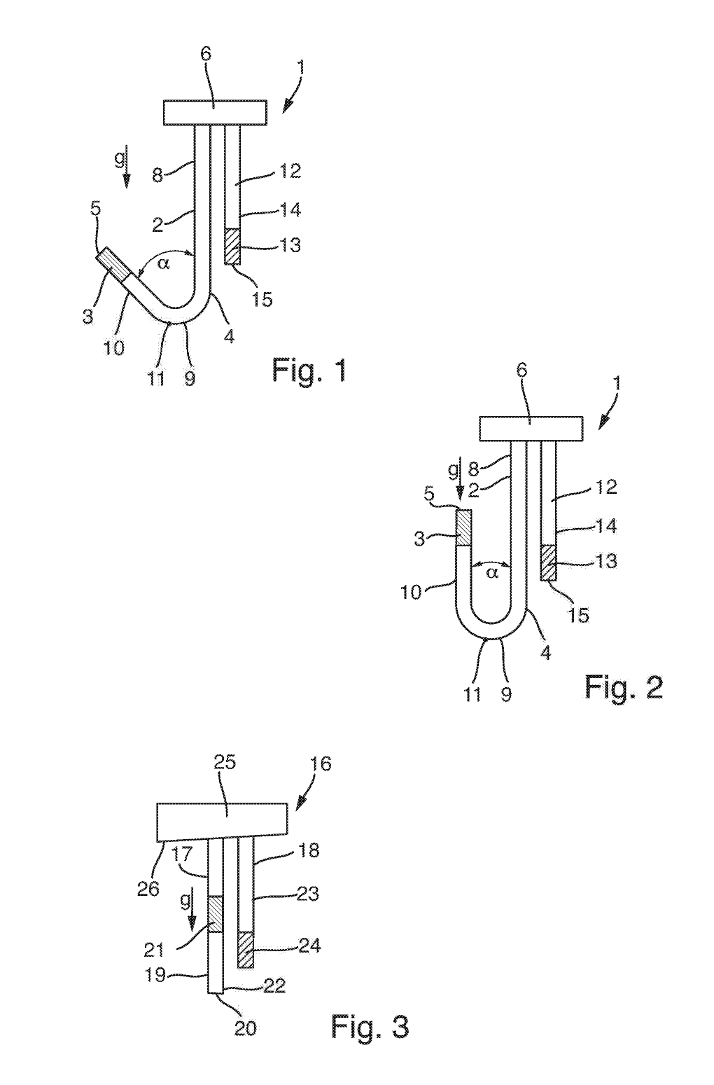

FIG. 1 schematic representation of a first example of an embodiment of a measuring transducer of a thermal, flow measuring device of the invention;

FIG. 2 schematic representation of a second example of an embodiment of a measuring transducer of a thermal, flow measuring device of the invention;

FIG. 3 schematic representation of a third example of an embodiment of a measuring transducer of a thermal, flow measuring device of the invention;

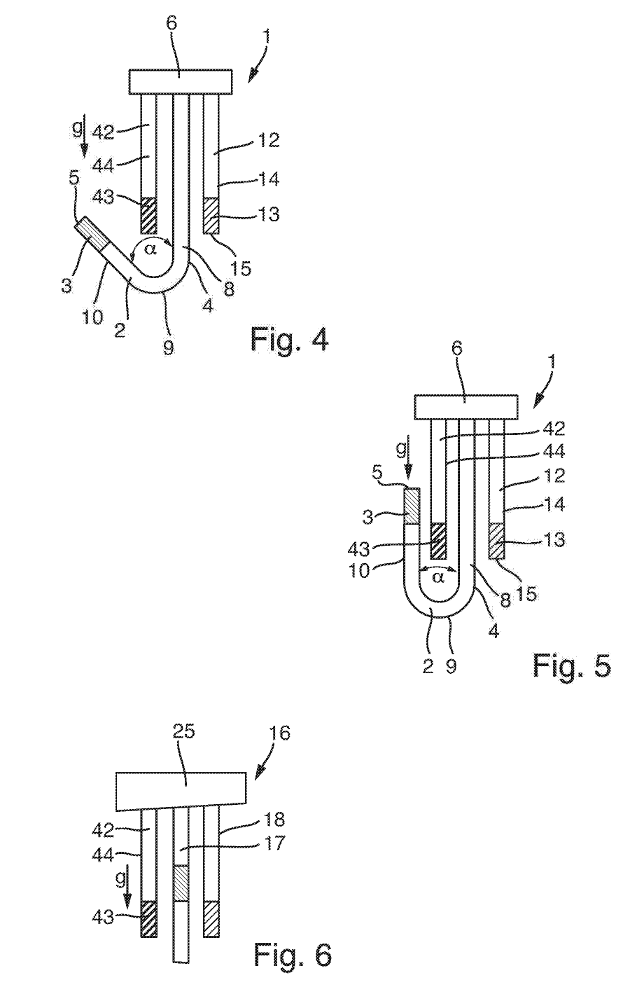

FIG. 4 schematic representation of a fourth example of an embodiment of a measuring transducer of a thermal, flow measuring device of the invention;

FIG. 5 schematic representation of a fifth example of an embodiment of a measuring transducer of a thermal, flow measuring device of the invention;

FIG. 6 schematic representation of a sixth example of an embodiment of a measuring transducer of a thermal, flow measuring device of the invention;

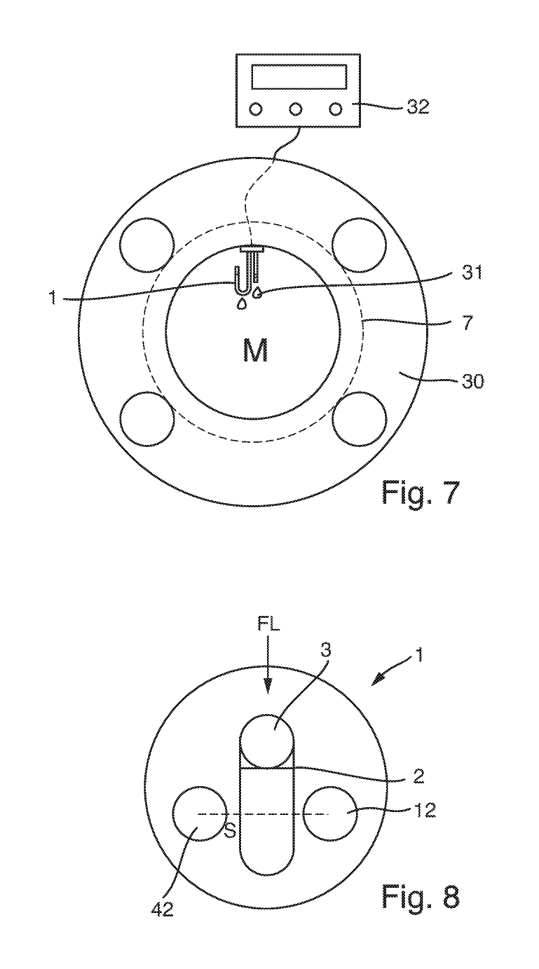

FIG. 7 schematic representation of a flow measuring device of the invention in a tube section;

FIG. 8 plan view of the example of an embodiment of FIG. 4;

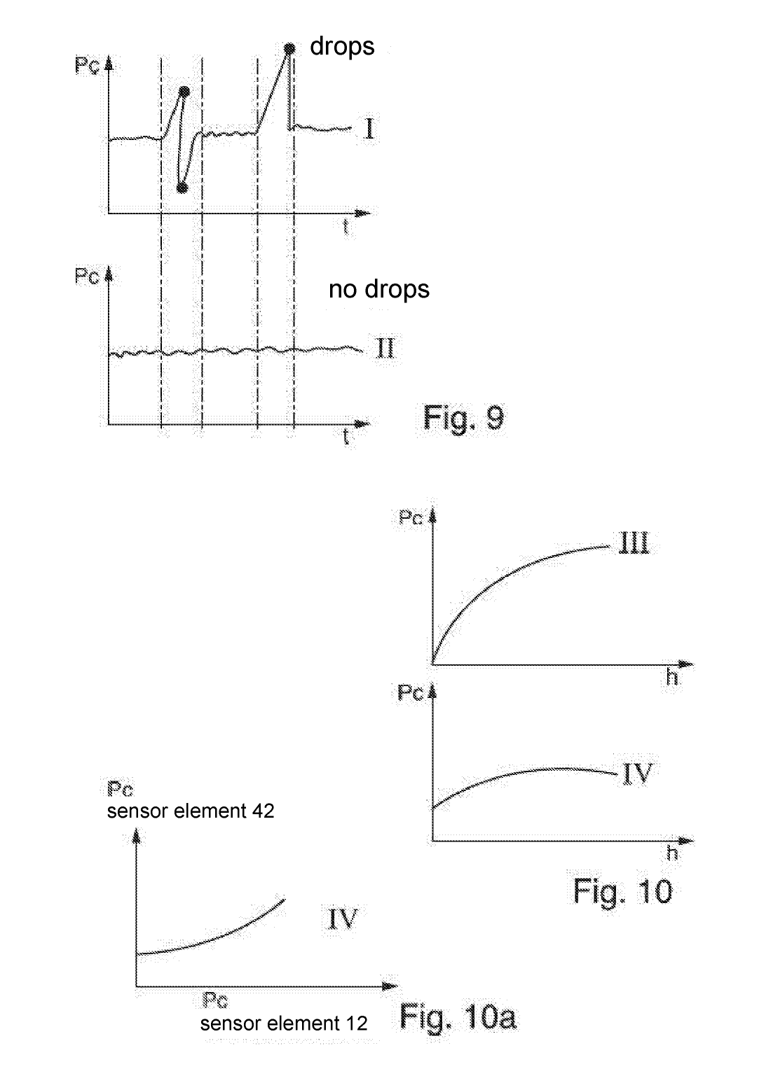

FIG. 9 schematic representation of the power coefficient as a function of time; and

FIG. 10 schematic representations of power coefficient as a function of heat transfer coeffficient.

Thermal, flow measuring devices have been used for decades in process measurements technology. The measuring principle is generally known to those skilled in the art. A construction of a thermal, flow measuring device is disclosed in EP 2 282 179 B1. In such case, the measuring transducer of the sensor of the flow measuring device includes at least two pin-shaped sleeves, so-called prongs, in which at least one temperature sensor and one heating means are terminally arranged. For industrial application, the measuring transducer is installed in a measuring tube; the resistance thermometer can, however, also be mounted directly in the pipeline. One of the two resistance thermometers is a so-called active sensor element, which is heated by means of a heating unit. The heating unit is either an additional resistance heater, or, in the case of the resistance thermometer, a resistance element, e.g. an RTD (Resistance Temperature Detector) sensor, which is heated by conversion of electrical power, e.g. by a corresponding variation of the electrical measuring current. In the case of the second resistance thermometer, it is a so-called passive sensor element: it measures the temperature of the medium. Of course, also the passive sensor element can be embodied to be heatable, so that the two sensor elements can be operated alternately as passive or active sensor element.

The resistance thermometers can be embodied individually or the two can be embodied as one heatable resistance thermometer and be, for example, a platinum element, as also commercially available under the designations, PT10, PT100 and PT1000.

Usually in a thermal, flow measuring device, a heatable resistance thermometer is so heated that a fixed temperature difference exists between the two resistance thermometers. Alternatively, it is also known to supply a constant heating power via a control- and/or evaluation unit.

If there is no flow happening in the measuring tube, then a constant amount of heat per unit time is required for maintaining the predetermined temperature difference. If, in contrast, the medium to be measured is moving, then the cooling of the heated resistance thermometer depends essentially on the specific mass flow (mass flow per unit area) of the medium flowing past. Since the medium is colder than the heated resistance thermometer, the flowing medium transports heat away from the heated resistance thermometer. In order thus in the case of a flowing medium to maintain the fixed temperature difference between the two resistance thermometers, an increased heating power is required for the heated resistance thermometer. The increased heating power is a measure for the mass flow, i.e. the mass flow rate of the medium through the pipeline.

If, in contrast, a constant heating power is supplied, then, as a result of the flow of the medium, the temperature difference between the two resistance thermometers lessens. The particular temperature difference is then a measure for the mass flow of the medium through the pipeline, or through the measuring tube, as the case may be.

There is, thus, a functional relationship between the heating energy needed for heating the resistance thermometer and the mass flow through a pipeline, or through a measuring tube, as the case may be. The dependence of the heat transfer coefficient on the mass flow of the medium through the measuring tube, or through the pipeline, is used in thermal, flow measuring devices for determining the mass flow. Devices, which operate based on such principle, are sold by the applicant under the marks, ‘t-switch’, ‘t-trend’ and ‘t-mass’.

FIG. 1 shows a schematic representation of a terminal section of a measuring transducer 1 of a first thermal, flow measuring device of the invention. Such a measuring transducer is usually connected with a transmitter. Corresponding measuring devices with measuring transducer and transmitter have been sold by the applicant for many years.

The measuring transducer shown in FIG. 1 has a first sensor element 2 with a hook-shape. Such sensor element includes at least one heating means 3, which is arranged in a metal shell 4 bent into a hook-shape. Heating means 3 can be embodied as a heatable temperature sensor, especially as a heatable resistance thermometer, and be arranged terminally in the metal sleeve 4. Metal sleeve 4 has an end face 5, which is flowed around by a measured medium M. The heat input from the heating means 3 into the measured medium occurs primarily along the end face 5.

The measuring transducer 1 includes additionally a platform in the form of a mounting piece 6, with which the measuring transducer can be mounted to a measuring tube 7 or a pipeline. The particular mounting piece in FIG. 1 is a plate, to which the sensor element 2 is connected. A typical connection is e.g. a welded connection. The mounting piece 6 can, however, have many other embodiments and geometries. It must only have a sufficiently broad surface for the affixing and separation of sensor elements of the measuring transducer 1 on a pipe.

The pin-shaped metal sleeve of the sensor element 2 includes starting from the mounting piece 6, first of all, a first portion 8, where the metal sleeve is linear or straight.

Following the first portion 8 is a second portion 9, where the pin-shaped metal sleeve has a hook- or arc shaped curve.

Following this second portion 9 is a third portion 10. This portion is again straight.

The first and third portions 8 and 10 form, as shown in FIG. 1, an angle α of less than 90°, especially 20-70°.

The hook shaped sensor element 2 includes terminally, thus in the third portion 10, the heating means 3.

Besides the hook-shaped sensor element 2, arranged in FIG. 1 on the mounting piece 6 is also a straight sensor element 12. This includes a metal shell 14, in which a temperature sensor 13 is terminally arranged. This can be heated or unheated and ascertains the temperature of the medium.

The second sensor element can in an alternative embodiment also only comprise said temperature sensor, which can be arranged in the shell of the first sensor element. Important for this alternative embodiment, however, is a thermal decoupling between the heating means and the temperature sensor. The thermal insulation to achieve this, is, however, most often more expensive than providing separated sensor elements, each with its own metal sleeve. Therefore, this alternative embodiment is less preferred.

While the heat input from the heating means 3 into the measured medium M is disturbed by droplet formation, the droplet formation on the temperature sensor, which ascertains the temperature of the medium, is unremarkable. The temperature of the droplet is essentially the temperature of the measured medium.

The medium, i.e. the measured medium, is preferably vaporous or gaseous. Such media can entrain e.g. liquid media, which deposit on the sensor surface. Another case is condensation.

For understanding the basic concept of the present invention, the hook shaped sensor element should be understood in such a manner that the sensor element, especially the pin-shaped metal sleeve, has a point 11 on the wall of the metal sleeve 4, which has a minimum potential energy in the gravitational field. This is, thus, in the gravitational direction g the lowest point of the wall.

Heating means 3 of the sensor element 2 is arranged in the gravitational direction above said point and spaced from said point 11 with a separation of at least two times the diameter of the metal sleeve 4, preferably 4-10 times the diameter of the metal sleeve 4.

Measuring transducer 1 includes additionally a second sensor element 12. This second sensor element 12 includes a temperature sensor 13 and a metal shell 14 with a linear longitudinal axis over the total course of the metal sleeve 14. Metal sleeve 14 has an end face 15, which is swept by measured medium M. Terminally arranged within the metal sleeve 14 is the temperature sensor 13. Temperature sensor 13 serves for ascertaining the temperature of the medium. Sensor element 12 is, thus, a passive sensor element. The temperature sensor does not, consequently, have to be heatable. It can, however, optionally have such functionality.

FIG. 2 shows a second example of an embodiment of a measuring transducer of the invention. This example of an embodiment differs from FIG. 1, in that the portions 8 and 10 of the sensor element 2 enclose an angle α of 0°. Portions 8 and 10 are, thus, parallel to one another.

All additional elements of the measuring transducer and geometric embodiments are embodied analogously to FIG. 1.

FIG. 7 shows a preferred installation of the measuring transducer of FIG. 2 in a pipe 7 for the flow measuring device of the invention. In the present case, pipe 7 is a measuring tube. Mounting piece 6 is fixed on the inner surface of the measuring tube in FIG. 7. However, various other options can be utilized for installation in the pipe. Also, the installed position can be varied as much as desired. However, attention must be paid in the installation that the medium collects on the outermost points and does not flow on the metal sleeve toward the mounting piece. Of course, the measuring transducer 1 can also be positioned in the pipe 7 by means of a retractable assembly. This is especially advantageous in the case of greater nominal diameters, especially DN greater than DN100. In the present case, pipe 7 has terminal flanges 30, which, however, are not subject matter of the invention.

Besides the measuring transducer 1, the flow measuring device also includes a control- and/or evaluation unit 32. FIG. 7 also shows the droplet formation schematically. Droplets 31 form on the end face 15 of the sensor element 12 and at the point 11 of the sensor element 2. This enables the heating means 3 to provide a disturbance free heat input into the medium, since heat transfer is not hindered by droplets.

FIG. 3 shows a third example of an embodiment of a measuring transducer 16 of the invention. Measuring transducer 16 includes at least a first and a second sensor element 17 and 18.

The first sensor element 17 has a straight metal sleeve 19 with a straight longitudinal axis.

First sensor element 17 includes a point 20 on the wall of the metal sleeve 19 with a minimum potential energy in the gravitational field. It is, thus, the lowest point of the wall in the gravitational direction g.

First sensor element 17 includes a heating means 21, which is arranged in the gravitational direction g above said point 20 and is spaced from said point 20 with a separation of preferably at least two times the diameter of the metal sleeve 19, preferably 4-10 times the diameter of the metal sleeve 19. Heating means 21 is a heatable temperature sensor.

In the region 22 below the heating means 21, the metal sleeve can have different forms deviating from FIG. 3. It can e.g. get narrower and/or be bent, in order to achieve a better draining of the droplets.

As already provided in FIGS. 1 and 2, also in the case of the measuring transducer 16 of FIG. 3, a mounting piece 25 is present for securing the sensor elements 17 and 18 to a pipe.

Sensor element 18 includes a metal shell 23 with a temperature sensor 24, which serves for ascertaining the temperature of the medium. This temperature sensor need not absolutely be heatable. The position of the temperature sensor 24 within the metal sleeve 19 need also not be terminal. Thus, temperature sensor 24 can be arranged at any height along the longitudinal axis of the metal sleeve 19. This holds analogously also for the temperature sensor of the sensor element 12 in FIGS. 1 and 2.

Mounting piece 25 can likewise have a drainage geometry 26, in order to avoid a “showering” of the sensor elements and to divert droplets formed on the mounting piece to an edge. In the concrete case of FIG. 3, the drainage geometry is an area extending inclined to a longitudinal axis of the measuring transducer 16 and in contact with the measured medium M and on which, consequently, droplets can deposit.

Second sensor element 18 is embodied analogously to the sensor element 12 of FIGS. 1 and 2. Especially advantageous is when the heating means 21 and the temperature sensor 24 of the sensor elements 17 and 18 are arranged essentially at equal height. Essentially means here that a variance of, for instance, a half diameter of the metal sleeve 19 can occur. This is especially advantageous, in order with heating means and temperature sensor to measure at the same height of the temperature profile of the medium.

The measuring transducer of FIGS. 1-3 enables, due to the special arrangement of the heating means 3 and 21 within the respective metal sleeves of the respective sensor elements, a measuring essentially undisturbed by droplets.

In FIGS. 4-6, the respective measuring transducers 6 and 25 are supplemented by an extra sensor element 42. All other components of FIGS. 4-6 are of construction equal to that of FIGS. 1 and 2.

Sensor element 42 is a second active and a third sensor element, thus a sensor element with a heating means 43 arranged terminally in a metal shell 44. While in the case of the sensor elements 12 and 18 the positioning of the temperature sensor is insignificant, the heating means 43 of the third sensor element 43 should be arranged at the lowest point of the sensor element in the gravitational direction. At this position, drop formation occurs, to the extent that the medium tends to form drops at the measuring conditions.

The presence of the third sensor element means that the measuring transducer, i.e. the flow transducer, can not only measure disturbance freely, in spite of droplet formation. Instead, it is now possible to detect droplet formation. This will be explained in greater detail below:

The measurement signals of the heating means 3 and 43 of the active sensor elements 2 and 42 are registered by a control- and/or evaluation unit 32.

By comparison of the two measurements, droplet formation can be detected. In such case, it can be assumed that, in the case of droplet formation, the droplets move toward the hook and collect at the point 11. This measurement signal is, consequently, transmitted disturbance freely. In contrast, there collect in the region of the sensor element 42, where the heating means 43 is arranged, droplets and these corrupt the measurement result. If the two measurement signals of the sensor elements 2 and 42 diverge, then droplet formation has occurred.

The terminology, heating means, in the sense of the present invention, means not only a monolithic element but, instead, also possibly an assembly of a separate heating element and a separate temperature sensor. Heatable means in this connection that an opportunity for heating is provided, be it by a separate heating element as part of the assembly or due to a heating by the resistance thermometer. The heatable temperature sensor can, thus, be operated by the control- and/or evaluation unit as a passive (unheated) or active (heated) sensor element.

Thus, in the case of failure of a sensor element, e.g. of the sensor element 12, the flow sensor can still be operated. The control- and/or evaluation unit switches the heating mode of the heating means 43 off and operates the sensor element 42 as a passive sensor element. Freely, in this case, droplet detection can no longer be performed. However, an emergency operation can at least assure continuance of the flow measurement.

Alternatively, by comparing the measurement signals of the two operating modes, a drift of the sensor can be recognized and, in given cases, quantified, to the extent that the medium tends not to form droplets. Drift shows itself as a change of the thermal resistance of the sensor. This leads to a change of the heat transfer from the heating means into the medium in the case of equal, i.e. constant, flow conditions. As a result, the flow measuring device ascertains another value for the power coefficient. The presence or absence of drift can be checked by the flow measuring device of the invention and especially preferably also quantified. Measured value comparison of the measurement signals of the two active sensor elements 12 and 42 assures drift detection.

The temperature sensors and heating means illustrated in FIGS. 4-6 are ideally arranged and embodied in such a manner that all these elements are at one height. A maximum deviation of the arrangement of a half diameter of a metal shell is set in such case. Ideally, all metal sleeves and the same diameter.

Of course, the sensor can be supplemented by other active or passive sensor elements.

In the above-described embodiments, always a point is described, where droplet formation takes place. In contrast, the entire small metal tube can also be coated with a liquid film, which, however, does not or only slightly influence the measuring and is not comparable with a hanging drop.

In the case of the variants of a measuring transducer shown in FIGS. 1-3 and the additional variants discussed in the description, the respective metal sleeves and/or mounting pieces can be produced by means of a 3D-printing method for metal objects. This includes, among others, also selective laser melting.

FIG. 8 shows a plan view for clarification of the flow direction and the arrangement of the respective sensor elements of FIG. 4.

The second and the third sensor element 12 and 42 define a connecting line S. This is perpendicular in FIG. 8 to the flow direction FL. The connecting line can preferably also be arranged at an angle between 80-100° to the flow direction FL. This arrangement is advantageous, however, not absolutely required.

The hook-shaped sensor element 2 is arranged and oriented in such a manner that the heating means 3, especially the heatable temperature sensor, of the first sensor element 2 is arranged in the flow direction before the temperature sensor of the second sensor element 12 and before the connecting line S. Thus, the heating means is the first element to be flowed against by an approaching flow.

The flow in the front region is not perturbed by other sensor elements. Therefore, the measuring at this position is especially preferred.

FIG. 9 shows power coefficient as a function of time in the case of the flow measurement. A corresponding measuring transducer based on the construction of FIG. 4 can correspondingly register such a measurement curve.

The upper measurement curve I represents a measurement, such as registered by the third sensor element 42. Peaks are present. These peaks can be positive or negative. A peak results from the forming of a droplet and falls to normal level as soon as the drop falls off.

In contrast, the lower measurement curve II has no such peaks. This is because the drops do not collect in the region, in which a heat input into the medium occurs. Some noise is present but no peak. Such a measurement curve II can be achieved with the bent, first sensor element 2.

In normal regions, thus in regions between peaks, an averaging of the measured values of the first and third sensor elements can occur, in order to achieve a higher accuracy of measurement.

Also, a redundant monitoring of the first and third sensor elements 2 and 42 is possible. This can, of course, occur only in the regions of the curve lacking peaks. Corresponding desired values when it concerns a peak and when not can be defined and compared with actual values. In this way, the two sensor elements, the first and the third, can be monitored for drift.

The scope of the droplet formation, thus the size of the droplets, can additionally be quantified by comparing the two measurement curves I and II.

FIG. 10 shows power coefficient as a function of the heat transfer coeffficient. Measurement curve III, in such case, is for measurement with the sensor element 42 and measurement curve IV is for measurement with the sensor element 2.

A correlation curve can be created therefrom and a computational relationship ascertained. The control- and evaluation unit can create this correlation curve at different times in measurement operation and compare such with a desired specification. Depending on size of the deviation from the desired specification, it can be decided whether a sensor drift is present or not.

### LIST OF REFERENCE CHARACTERS

1 measuring transducer
2 sensor element
3 heating means
4 metal sleeve
5 end face
6 mounting piece
7 pipe
8 portion
9 portion
10 portion
11 point
12 sensor element
13 temperature sensor
14 metal sleeve
15 end face
16 measuring transducer
17 sensor element
18 sensor element
19 metal sleeve
20 end face
21 heating means
22 region
23 metal sleeve
24 temperature sensor
25 mounting piece
26 drainage geometry
30 flange
31 droplets
32 control- and/or evaluation unit
42 sensor element
43 temperature sensor
44 metal sleeve
α angle
M measured medium
S connecting line
FL flow direction

1-12. (canceled)

13. A thermal flow measuring device for ascertaining a mass flow or a flow velocity of a medium in a pipe, comprising:
at least one measuring transducer with at least a first and a second sensor element; and
at least one heating means, wherein:
said first sensor element has a pin-shaped metal sleeve, which has a lowest point on a wall of said metal sleeve in the gravitational direction; and
there is arranged in said metal sleeve said at least one heating means, especially a heatable temperature sensor said heating means is arranged in said metal sleeve and above said lowest point in the gravitational direction, in such a manner that the maximum heat input per unit area from said heating means into the medium occurs in the gravitational direction above said lowest point.

14. The thermal, flow measuring device as claimed in claim 13 wherein:
said heating means is preferably spaced by more than twice the diameter of said metal sleeve, especially preferably by 4 to 10 times the diameter of said metal sleeve, from said lowest point.

15. The thermal, flow measuring device as claimed in claim 13, wherein:
said metal sleeve has a bend and said lowest point is arranged in the bend.

16. The thermal, flow measuring device as claimed in claim 13, wherein:
said metal sleeve is straight and said lowest point is arranged terminally on said metal sleeve.

17. The thermal, flow measuring device as claimed in claim 13, wherein:
said second sensor element has a metal shell, in which a temperature sensor is arranged, said temperature sensor in said second sensor element is arranged essentially at the same height of the measuring transducer as said heating means of said first sensor element.

18. The thermal, flow measuring device as claimed in claim 13, wherein:
said measuring transducer has a third sensor element, said third sensor element has a pin-shaped metal sleeve, which has a lowest point on a wall of said metal sleeve in the gravitational direction;
there is arranged in said metal sleeve at least one heating means, preferably a heatable temperature sensor; and
said heating means is arranged in said metal sleeve and in the gravitational direction in the region of the aforementioned point, in such a manner that the maximum heat input per unit area from said heating means into the medium occurs in the gravitational direction at said point.

19. The thermal, flow measuring device as claimed in claim 18, wherein:
said thermal, flow measuring device has a control- and/or evaluation unit, which is adapted:
for receiving measurement signals of said heating means of said first and said third sensor elements and/or values derived therefrom; and
for monitoring whether droplet formation is occurring on the third sensor element.

20. The thermal, flow measuring device as claimed in claim 18, wherein:
said thermal, flow measuring device has a control- and/or evaluation unit, which is adapted:
for receiving measurement signals of said heating means of said first and said third sensor elements and/or values derived therefrom; and
for monitoring whether one of the two aforementioned sensor elements has a drift.

21. The thermal, flow measuring device as claimed in claim 19, wherein:
said control- and/or evaluation unit is adapted for quantifying the scope of the droplet formation on said third sensor element and/or the drift of one of said two sensor elements with a heating means.

22. A method for ascertaining a mass flow or a flow velocity of a gaseous and/or vaporous medium in a pipe by means of a thermal, flow measuring device, which includes at least one measuring transducer with at least a first sensor element which sensor element is embodied in such a manner that the first sensor element has a heating means, preferably a heatable temperature sensor, comprising the steps of:
arranging the heating means in a pin-shaped shell, especially a metal shell;
embodying the pin-shaped shell in such a manner that a liquid, which in measurement operation has deposited on the shell surface, can drain into a region, in which droplet formation occurs; and
the heating means is in thermal contact with the measured medium and is arranged in such a manner in the shell that the maximum heat input per unit area into the measured medium from the heating means occurs above the region of droplet formation.

23. The use of the thermal, flow measuring device as claimed in claim 13 for detection of droplet formation during flow measurement.

24. The use of the thermal, flow measuring device as claimed in claim 13 for quantifying droplet formation and/or rate of droplet formation.
